(19) United States
(12) Patent Application Publication
(10) Pub. No.: US 2008/0013894 A1
(43) Pub. Date: Jan. 17, 2008

(54) Optical receptacle and sleeve

(75) Inventors: Shinichi Aoki, Kawasaki (JP); Makoto Miyoshi, Kawasaki (JP); Kazuya Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/636,504

(22) Filed: Dec. 11, 2006

(30) Foreign Application Priority Data
Jun. 28, 2006 (JP) 2006-178477

(51) Int. Cl. G02B 6/36

(52) U.S. Cl. 385/88

(57) ABSTRACT

An optical receptacle includes a fiber stub; and a sleeve having a sleeve main body where the fiber stub is installed, the sleeve supported by a supporting surface of a supporting member. In the optical receptacle, a leaning prevention member is provided at the sleeve; the leaning prevention member is formed so as to extend outward from the sleeve main body; and the leaning prevention member prevents leaning of the sleeve main body from the supporting surface by coming in contact with the supporting surface.

### BACKGROUND OF THE INVENTION

1. Field of the Invention

The present invention generally relates to optical receptacles and sleeves, and more specifically, to an optical receptacle having a sleeve and the sleeve.

2. Description of the Related Art

FIG. 1 is a cross-sectional view of a related art optical receptacle 1. As shown in FIG. 1, the optical receptacle 1 includes a fiber stub 2, a sleeve 5, a sleeve case 8, and others. The optical receptacle 1 is fixed to an optical device housing 9. The fiber stub 2 has a structure where an optical fiber 4 is provided in the center of the inside of the sleeve 5. The fiber stub 2 is installed inside the sleeve 5. FIG. 3 is a cross-sectional view of the fiber stub 2 in a case where a load is applied by the sleeve 5 with a slit forming part 7. As shown in FIG. 3, the slit forming part 7 is formed in the sleeve 5. The sleeve case 8 protects the sleeve 5.

In the optical receptacle 1 shown in FIG. 1, a plug ferrule 11 provided to a connector 10 is inserted in the sleeve 5. A contact surface 2a of the fiber stub 2 and a contact surface 11a of the plug ferrule 11 are connected so that the optical fiber 4 and an optical fiber 12 are optically connected to each other.

In the meantime, it is known that loss (insertion loss) due to connection occurs in a case where an optical waveguide is connected by the optical receptacle 1. This loss is caused by radiation from a connection part due to axis shift (shift of an optical axis) of each of the optical fibers 4 and 12.

In the related art optical receptacle 1, in order to prevent decrease of receiving level based on loss (insertion loss) due to radiation, connection using a split sleeve 5, namely a sleeve having a sleet forming part is used. See FIG. 3-(A). When the plug ferrule 11 of the connector 10 is inserted, the split sleeve 5 is elastically deformed so that optical axes of a pair of the ferrules 3 and 11 connected to each other are matched (oriented) by matching external configurations of the ferrules 3 and 11 to each other. Even if the plug ferrule 11 of the connector 10 is inserted wrongly with 100 μm order of magnitude error, it is possible to match the optical axes of the ferrules 3 and 11 because of an orienting effect.

In the related art optical receptacle 1, optical loss is drastically changed based on the external force applied to the connector 10. Because of this, in a large capacity main communication device, in order to prevent the external force from being applied to the optical receptacle 1, a curing process or a forming process of the optical fiber is implemented.

Recently, advancement or accelerating of the communication device such as a router device has been progressing. Therefore, an optical interface is used even in a small-size router. It is rare to conduct a large size laying works for providing the small-size router, and a simple fiber laying is frequently used for the small-size router. In this case, if the curing process or the forming process of the optical fiber is not sufficient or hands or legs get caught in the optical fiber, a large force may be instantaneously applied to the optical fiber.

In order to guarantee stable communication even in this case, improvement of a wiggle characteristic is required. Here, the wiggle characteristic is a change of optical loss in the case where the external force is applied to the optical receptacle 1.

FIG. 2 is a schematic view for explaining the wiggle characteristic.

Referring to FIG. 2, a weight 18 is attached to an optical fiber 19 provided in a direction perpendicular to the ground via a weight fixing structure 17 in a state where an optical connector 16 provided to an optical module 15 is held level even with the ground. The wiggle characteristic is a rotational angle and change of loss when the optical connector 16 is rotated in a single right direction and a single left direction in a state where a load is applied to the optical fiber 19 by the weight 18.

Generally, influence of external force on the optical receptacle 1 depends on the structure of the optical receptacle 1. Since an engaging part is not rotationally symmetric about the optical axis, there is an angle characteristic in a load bearing capacity related to the external force. In addition, if elastic deformation of the sleeve 5 occurs due to the external force, different characteristics in the right and left rotational directions are generally found.

Because of this, the angle characteristics in the right rotational direction and left rotational direction are discussed as a set when the wiggle characteristic is discussed. If the wiggle characteristic is bad in a specific direction, when an external force is applied in that direction, the insertion loss is drastically changed. As a result of this, the receiving level is changed at the opposite station. This may cause communication error.

It is known that the wiggle characteristic itself is determined by an amount of shift of the optical axis that is generated at an orient part of the optical axis by the external force. The related art split sleeve 5 holds the plug ferrule 11 by elastic deformation when the plug ferrule 11 is connected to the fiber stub 2. See FIG. 3-(A). However, a holding force for holding the connection between plug ferrule 11 and the fiber stub 2 by the split sleeve 5 is weak.

Because of this, when such a load is applied, the split sleeve 5 cannot withstand the external force. As a result of this, the ferrules 2 and 11 may be shifted in a direction where the external force is applied as shown in FIG. 3-(B) or an angle θ formed by the end surfaces may be expanded as shown in FIG. 4. Here, FIG. 4 is a cross-sectional view for explaining problems occurring in the sleeve 5 with the slit forming part 7.

At this time, elastic deformation of the split sleeve 5 takes place so that the slit forming part 7 opens. Hypothetically if a target value of the wiggle is, for example, 1.6 dB, according to the result of analysis of a model where Gaussian approximation of a propagation mode of the optical fiber is made, it is necessary to hold a shift amount “d” (see FIG. 4) of the optical fibers 4 and 12 to a value equal to or less than 3.04 μm (when 0 is zero (0)) or an angle “θ” formed by the contact surfaces 2a and 11a to a value equal to or less than 2.35 degrees (when “d” is zero (0)). In the case of the split sleeve 5, since change of the shift amount “d” or the angle “θ” is large, it is typical that the wiggle characteristic exceeds 10 dB.

On the other hand, as an alternative way to prevent the elastic deformation causing the slit forming part 7 to open, a precision sleeve 6 instead of the split sleeve 5 may be used. The precision sleeve 6 is minutely processed so that its internal diameter is greater by several μm than the external diameters of the ferrules where the ferrules are inserted into the internal diameter of the sleeve 6. In an example of the precision sleeve 6 shown in FIG. 5, external diameters of the ferrules 2 and 11 are equal to or greater than 1.2485 mm and equal to or less than 1.2495 mm. An internal diameter Φ of the precision sleeve 6 is equal to or greater than 1.251 mm and equal to or less than 1.252 mm. Here, FIG. 5 is a cross-sectional view for explaining leaning of the fiber stub.

While the precision sleeve 6 has improvement compared to the split sleeve 5, further improvement of the characteristic is required in order to improve communication quality.

As a reason of the wiggle when the precision sleeve 6 is applied, there is “backlash” or “leaning of sleeve”. Here, “backlash” is an angle between the optical axes and an axis shift generated in a defined precision. “Leaning of sleeve” is generated in processing precision of the fiber stubs 2 and 12.

As shown in FIG. 5, it is assumed that the sleeve leans at θs as a maximum due to the stub processing precision inside of the sleeve. It may be difficult to reduce degradation of the wiggle characteristic due to the inclination θs by simply applying the precision sleeve 6.

For the further improvement of the wiggle characteristic in the precision sleeve 6, it is necessary to consider the backlash of the ferrules 3 and 11 and the leaning of the precision sleeve 6. A case follows where θ is a maximum when “d” is zero.

FIG. 6 is a cross-sectional view for explaining a worst case condition model of loss. As shown in FIG. 6, when there is no leaning of the precision sleeve 6, namely θs is zero (0) degrees and θ is 0.082 degrees as a maximum. When a target value of the wiggle characteristic is 1.6 dB, since a limiting (critical) value of “θ+θs” is 2.35 degrees, it is necessary to make θs equal to or less than 2.27 degrees.

### SUMMARY OF THE INVENTION

Accordingly, embodiments of the present invention may provide a novel and useful optical receptacle and sleeve solving one or more of the problems discussed above.

More specifically, the embodiments of the present invention may provide an optical receptacle wherein a signal level can be stabilized even if an external force is applied to a sleeve, and the sleeve.

One aspect of the present invention may be to provide an optical receptacle, including a fiber stub; and a sleeve having a sleeve main body where the fiber stub is installed, the sleeve supported by a supporting surface of a supporting member; wherein a leaning prevention member is provided at the sleeve; the leaning prevention member is formed so as to extend outward from the sleeve main body; and the leaning prevention member prevents leaning of the sleeve main body from the supporting surface by coming in contact with the supporting surface. The leaning prevention member may be a plate-shaped member having a structure where at least three portions extend in a radial manner from the center of the sleeve main body having a cylindrical-shaped configuration and an end part comes in contact with the supporting surface. Length in a longitudinal direction of the plate-shaped member may be shorter than length between a contact surface of the fiber stub and the supporting surface. The leaning prevention member may be provided on the sleeve main body having a cylindrical-shaped configuration in a ring shape; and an end surface of the leaning prevention member may come in contact with the supporting surface. A slit forming part extending in a longitudinal direction may be formed in the sleeve main body.

The other aspect of the present invention may be to provide a sleeve provided in an optical receptacle where a fiber stub is provided, the sleeve being supported by a supporting surface of a supporting member, the sleeve including: a sleeve main body where the fiber stub is installed; and a leaning prevention member formed so as to extend outward from the sleeve main body, the leaning prevention member being configured to prevent leaning of the sleeve main body from the supporting surface by coming in contact with the supporting surface.

According to the above-mentioned optical receptacle and sleeve, since the wiggle characteristic can be improved, even if the external force is applied to the sleeve, the signal level can be stabilized. Therefore, communication error at an opposite station can be prevented.

Other objects, features, and advantages of the present invention will be come more apparent from the following detailed description when read in conjunction with the accompanying drawings.

### BRIEF DESCRIPTION OF THE DRAWINGS

FIG. 1 is a cross-sectional view of a related art optical receptacle;

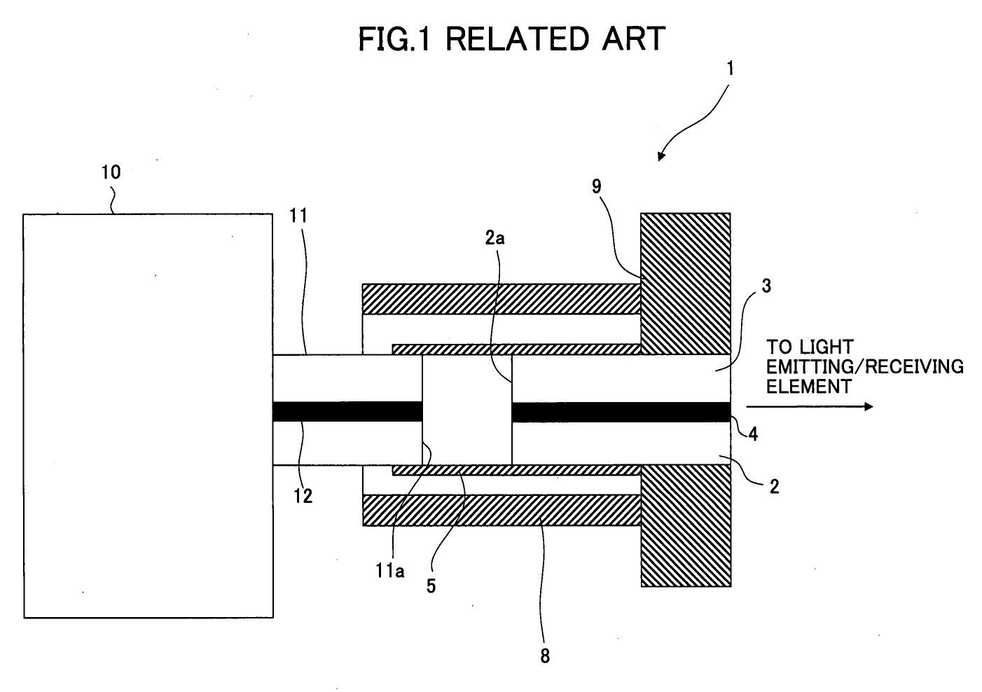

FIG. 2 is a schematic view for explaining a wiggle characteristic;

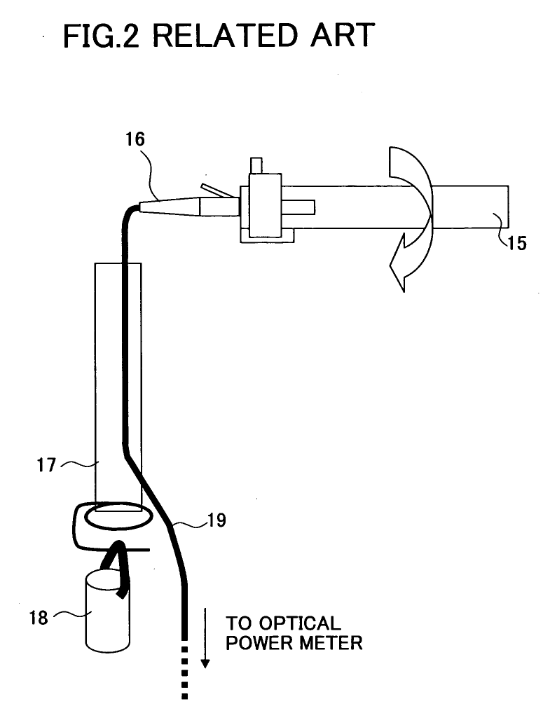

FIG. 3 is a cross-sectional view of a fiber stub in a case where a load is applied by a sleeve with a slit forming part;

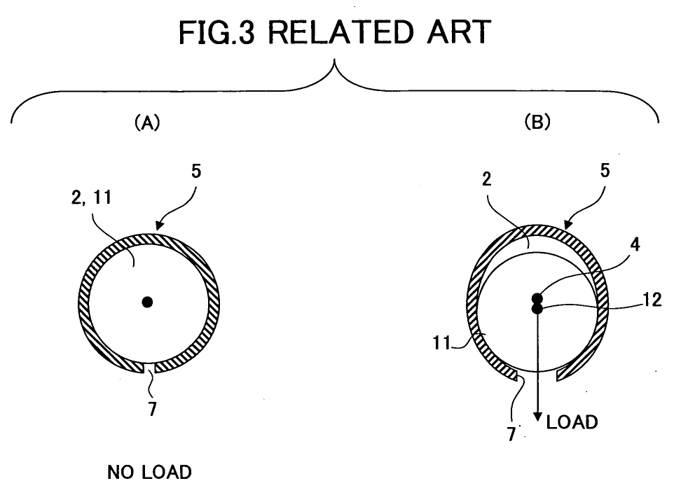

FIG. 4 is a cross-sectional view for explaining problems occurring in the sleeve with the slit forming part;

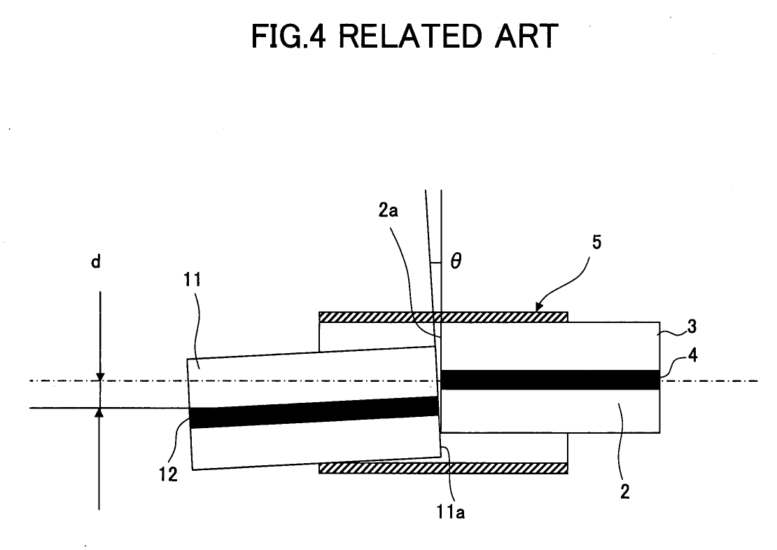

FIG. 5 is a cross-sectional view for explaining leaning of the fiber stub;

FIG. 6 is a cross-sectional view for explaining a worst case condition model of loss;

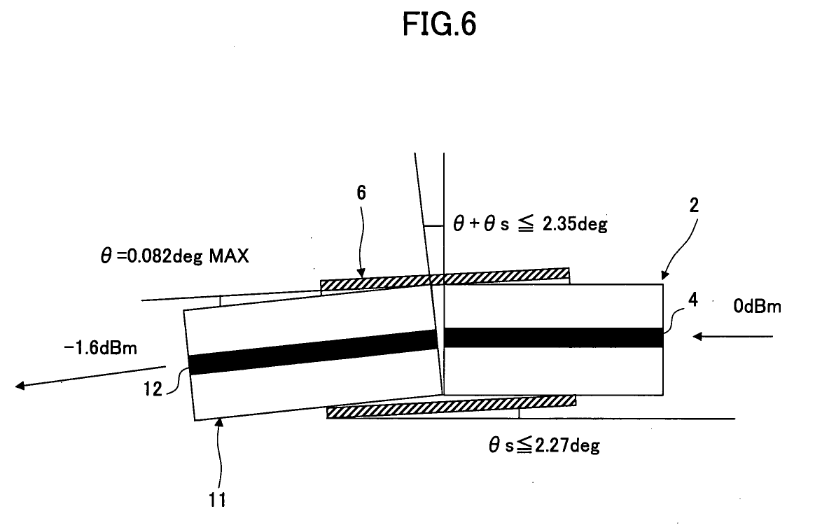

FIG. 7 is a cross-sectional view of an optical receptacle of an embodiment of the present invention;

FIG. 8 is a view showing a first example of a sleeve provided in the optical receptacle of the embodiment of the present invention, FIG. 8-(A) is a left side view, and FIG. 8-(B) is a front view;

FIG. 9 is a cross-sectional view for explaining operation of the optical receptacle of an embodiment of the present invention;

FIG. 10 is a view showing a second example of a sleeve provided in the optical receptacle of the embodiment of the present invention, FIG. 10-(A) is a left side view, and FIG. 10-(B) is a front view;

FIG. 11 is a view showing a third example of a sleeve provided in the optical receptacle of the embodiment of the present invention, FIG. 11-(A) is a left side view, and FIG. 11-(B) is a front view; and

FIG. 12 is a view showing a fourth example of a sleeve provided in the optical receptacle of the embodiment of the present invention, FIG. 12-(A) is a left side view, and FIG. 12-(B) is a front view.

### DETAILED DESCRIPTION OF THE PREFERRED EMBODIMENTS

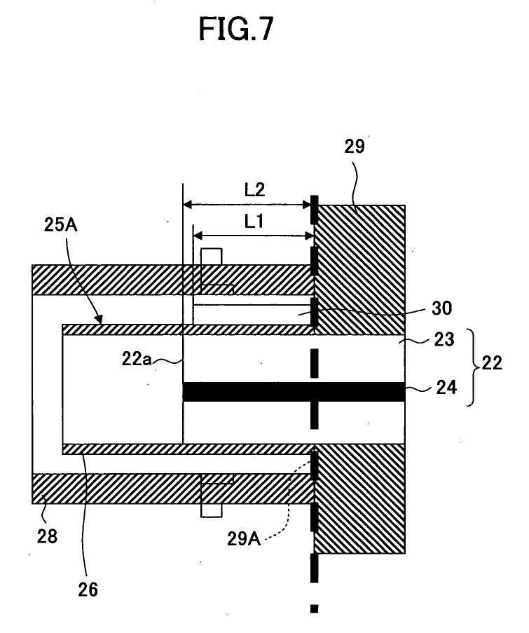

A description is given below, with reference to the FIG. 7 through FIG. 12 of embodiments of the present invention.

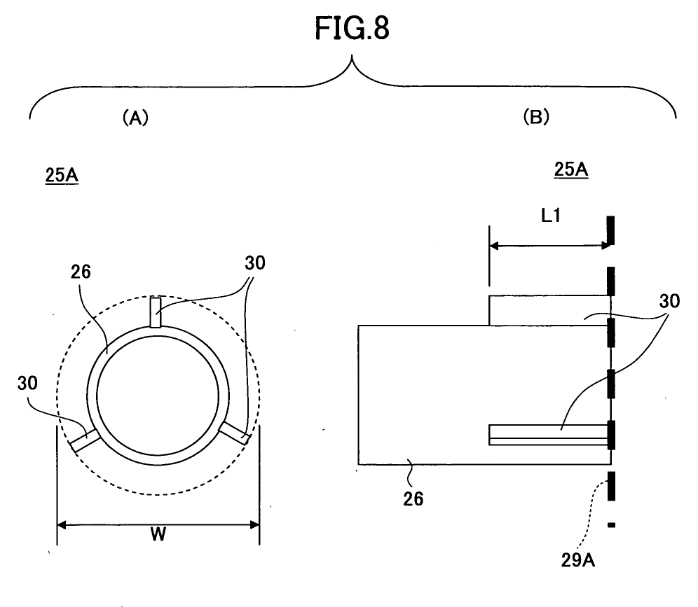

FIG. 7 is a cross-sectional view of an optical receptacle 20 of an embodiment of the present invention. FIG. 8 is a view showing a first example of a sleeve 25A provided in the optical receptacle 20 of the embodiment of the present invention, FIG. 8-(A) is a left side view, and FIG. 8-(B) is a front view. In FIG. 8, the sleeve 25A is enlarged.

As shown in FIG. 7, the optical receptacle 20 includes a fiber stub 22, the sleeve 25A, a sleeve case 28, and others. The optical receptacle 20 is fixed to an optical device housing 29. The optical device housing 29 is a communication device such as a router device. The fiber stub extends from a supporting surface 29A of the optical device housing 29.

The fiber stub 22 has a structure where an optical fiber 24 is provided in the center of a ferrule 23. The fiber stub 22 is installed inside the sleeve 25A.

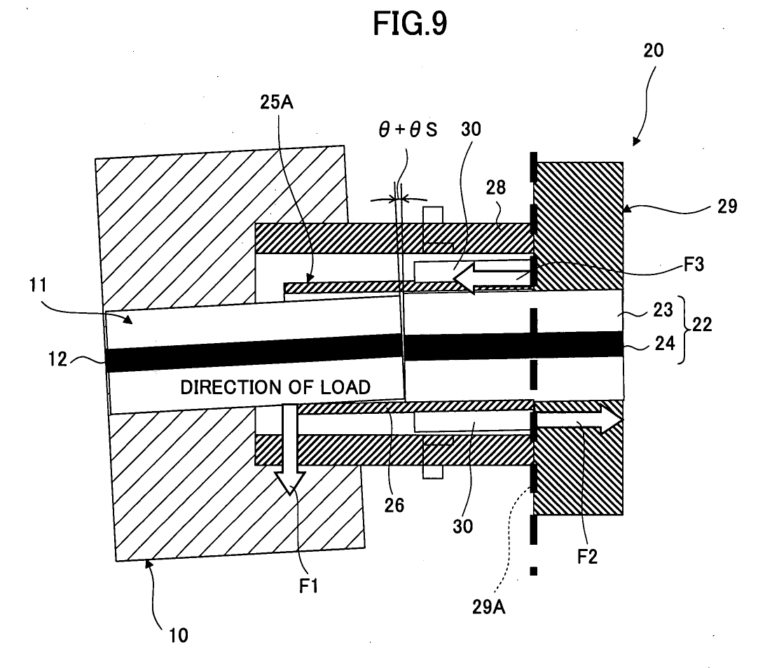

In this embodiment, the sleeve 25A is a precision sleeve where a slit forming part is not formed. The sleeve 25A is formed by a sleeve main body 26 and a leaning prevention plate 30. The sleeve main body 26 has a cylindrical-shaped configuration. An internal diameter of the sleeve main body 26 is minutely processed so as to be slightly greater than an external diameter of a plug ferrule 11 (see FIG. 9) inserted in the sleeve main body 26 by several μm.

The leaning prevention plate 30 extends outward from the sleeve main body 26. By the leaning prevention plate 30 and the supporting surface 29A contacting each other, leaning of the sleeve main body 26 against the supporting surface 29A can be prevented. In this embodiment of the present invention, three pieces of the leaning prevention plate 30 are formed on the sleeve main body 26 at even intervals.

In addition, the leaning prevention plate 30 may be formed in a body with the sleeve main body 26. The leaning prevention plate 30 may be fixed to the sleeve main body 26 by welding or the like. Furthermore, as shown in FIG. 7, the distance between an end part of the leaning prevention plate 30 and the supporting surface 29A, indicated by an arrow L1 in FIG. 7 and FIG. 8-(B), is shorter than the distance between the contact surface 22a and the supporting surface 29A of the fiber stub 22, indicated by an arrow L2 in FIG. 7 (L1<L2).

FIG. 9 is a cross-sectional view for explaining operation of the optical receptacle 20 of the embodiment of the present invention.

In the optical receptacle 20 shown in FIG. 9, a plug ferrule 11 provided in a connector 10 is inserted in the sleeve 25A. The contact surface 22a of the fiber stub 22 and a contact surface 11a of the plug ferrule 11 are connected so that the optical fiber 24 and an optical fiber 12 are optically connected to each other. The sleeve case 28 protects the sleeve 25 and fixed to the supporting surface 29A.

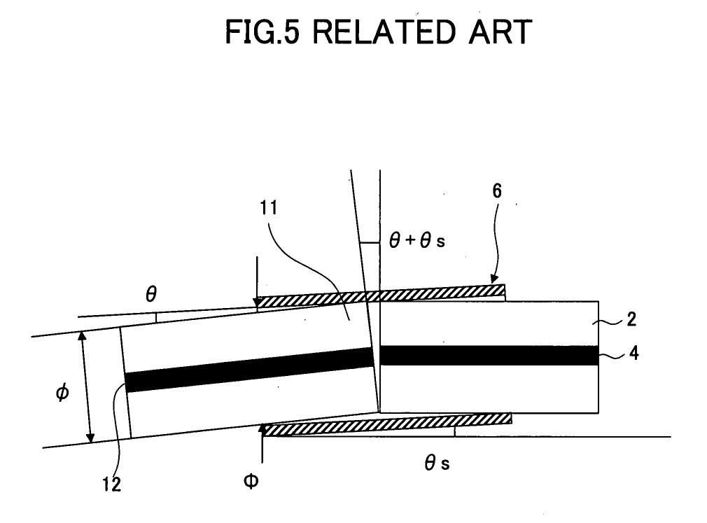

Next, a function of the leaning prevention plate 30 provided on the sleeve 25A of the embodiment of the present invention is discussed. As discussed above, the optical receptacle 20 of the embodiment of the present invention has a structure where plural leaning prevention plates 30 are provided on the outer periphery of the sleeve main body 26 in order to prevent the sleeve 25A from leaning, namely in order to prevent the inclination θs in FIG. 5.

A surface of the leaning prevention plate 30 coming in contact with the supporting surface 29A is flat and the leaning prevention plate 30 is adhered to the supporting surface 29A. In addition, as discussed above, the leaning prevention plates 30 are arranged in a radial manner around the sleeve main body 26 having the cylindrical-shape configuration. Because of this, as compared with the precision sleeve 6 shown in FIG. 5 having no leaning prevention plates 30, even if the external force is applied in a direction perpendicular to the optical axis, it is possible to improve stabilization against this.

In addition, as discussed above, the distance L1 in the longitudinal direction (optical axis direction) of the leaning prevention plate 30 is shorter than the distance L2 between the contact surface 22a and the supporting surface 29A of the fiber stub 22 (L1<L2). The distance L1 of the leaning prevention plate 30 does not directly influence the inclination θs of the sleeve 25A at the connection time of the connector 10.

However, in a case of a standard type optical receptacle 20, a connection part of the sleeve case 28 is situated in the vicinity of the contact surface 22a, namely the PC end surface, where the plug ferrule 11 and the fiber stub 22 come in contact with each other. Since the contact surface 22a and the learning prevention plate 30 may interfere with each other, it is generally preferable that the distance L1 does not allow the leaning prevention plate 30 to reach the contact surface 22a.

In addition, an external diameter indicated by an arrow “W” in FIG. 8-(A) of the sleeve 25A including the leaning prevention plate 30 also does not directly influence the inclination θs of the sleeve 25A. However, the external diameter indicated by an arrow “W” in FIG. 8-(A) of the sleeve 25A including the leaning prevention plate 30 may be a limitation on mounting. In the case of a standard type optical receptacle 20, the external configuration of the sleeve 25A including the leaning prevention plate 30 is not larger than that of the sleeve case 28. Considering the LC connector standard, the external diameter indicated by the arrow “W” in FIG. 8-(A) of the sleeve 25A including the leaning prevention plate 30 is equal to or less than 2.9 mm.

In addition, an allowable error Le of the supporting surface 29A is normally determined by the external diameter W of the leaning prevention plate 30 and the inclination θs of the sleeve 27A at the time of connection of the connector 10 being a target. The allowable error Le of the supporting surface 29A indicates a manufacturing error in the optical axial direction at an end point situated furthest from the center of the sleeve 25A and the leaning prevention structure.

At the end point, if an error from the center is equal to or less than the allowable error “Le” of the supporting surface 29A, the inclination of the sleeve 25A is equal to or less than θs in the ideal case. The average of a circular part of the sleeve 25A coming in contact with the supporting surface 29A can be substituted for the center of the sleeve 25A having imaginary coordinates. For example, if “W” equals to 2.5 mm, the allowable error Le at the supporting surface is approximately 99.1 μm.

Next, functions of the sleeve 25A and the optical receptacle 20 of the embodiment of the present invention are discussed with reference to FIG. 9.

There is extremely little play of the sleeve 25A fixed to the supporting surface 29A in three-dimensional directions, namely X, Y and Z directions. Zirconium oxide that is a material of the precision sleeve 25A has a limited deformation amount due to the external force.

In addition, an internal diameter of the precision sleeve 25A is processed in precision. The shift due to manufacturing error of the fiber stub 22 is maximum d=1.75 μm. In this case, while the loss is approximately 0.53 dB, this is a worst case value and almost no influence is applied in actuality.

FIG. 9 shows positional relationships of the plug ferrule 11, the fiber stub 22, and the sleeve 25A when the external force is applied to the connector 10. The external force applied to the connector 10 is applied to the plug ferrule 11. In the example shown in FIG. 9, a load F1 is applied downward.

On the other hand, the plug ferrule 11 is inclined at an angle of θs by the external force. Simultaneously, the plug ferrule 11 is inclined at angle of θ due to differences of the internal diameter of the plug ferrule 11 and the external configuration of the ferrule 23 (fiber stub 22). In other words, the contact surface 11a of the plug ferrule 11 is inclined at an angle of θ+θs with the contact surface 22a of the fiber stub 22.

External forces F2 and F3 generated at the leaning prevention plate 30 by the load F acts in substantially perpendicular directions compared to the supporting surface 29A, the supporting surface 29A adhering to the leaning prevention plate 30. In FIG. 9, the external force F2 generated at the leaning prevention plate 30 situated at the lower part acts as a force pressing the supporting surface 29A. On the other hand, the external force F3 generated at the leaning prevention plate 30 situated at the upper part acts as a force so that the leaning prevention plate 30 is separated from the supporting surface 29A.

However, the difference between the internal diameter of the sleeve 25A and the external configuration of the fiber stub 22 is extremely small. Therefore, the sleeve 25A is caught by the fiber stub 22, so that the sleeve 25A is securely prevented from leaving and the sleeve 25A remains fixed to the optical receptacle 20. Accordingly, since the sleeve 25A is supported by the supporting surface 29A, the inclination θs of the sleeve 25A does not exceed a target limitation value. Hence, optical loss at the angle of θ+θs can be limited to be equal to or less than the target value.

Thus, according to the optical receptacle 20 of the embodiment of the present invention, the falling of the sleeve 25A due to manufacturing unevenness of the fiber stub 22 is stabilized by the leaning prevention plate 30 adhering to the supporting surface 29A. Hence, it is possible to stabilize the wiggle characteristic.

In addition, according to the embodiment of the present invention, since the load (external force) is not directly applied to a base part of the fiber stub 22 provided by press fitting, all of loads are not applied to a press fitting part. Therefore, it is possible to improve reliability.

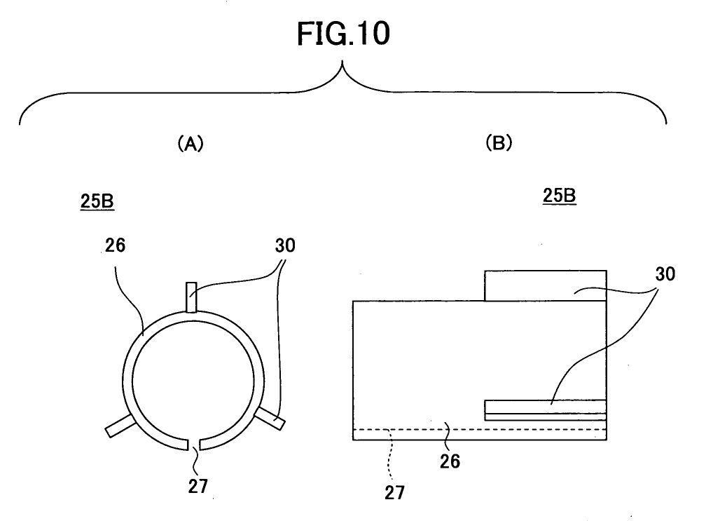

In addition, while it is most suitable to use the present invention in the precision sleeve as discussed above, the present invention can be applied to a split sleeve 25B as shown in FIG. 10 where the slit forming part 27 is formed in the sleeve main body 26. Here, FIG. 10 is a view showing a second example of a sleeve provided in the optical receptacle of the embodiment of the present invention, FIG. 10-(A) is a left side view, and FIG. 10-(B) is a front view.

As discussed above, the wiggle characteristic is improved by using the precision sleeve. Similarly, in the sleeve 25B where the slit 27 is formed, depending on the optical characteristic, it is possible to obtain a better characteristic as compared with the precision sleeve. In this case, depending on the optical characteristic, it may be possible to improve the wiggle characteristic by using the split sleeve 25B having the slit forming part 27.

In this case, it can be expected to improve the wiggle characteristic due to leaning of the split sleeve 25B having the slit forming part 27. However, a main reason of degradation of the wiggle characteristic of the sleeve 25B is the above-discussed elastic deformation. Therefore, the elastic deformation may not be prevented by the sleeve 25B. Thus, an effect achieved by the sleeve 25B may be limited.

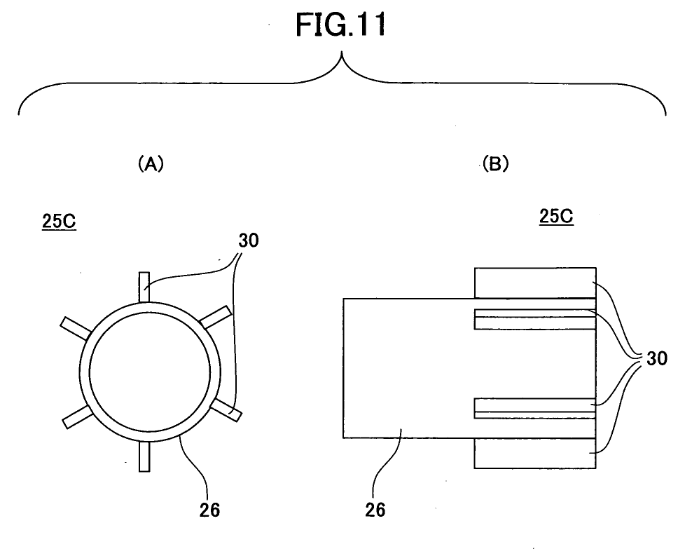

In addition, in the above-discussed example, three leaning prevention plates 30 are provided on the sleeve main body 26. However, the number of the leaning prevention plate 30 is not limited to three. For example, as shown in FIG. 11, six leaning prevention plates 30 may be provided on the sleeve main body 26. Here, FIG. 11 is a view showing a third example of a sleeve provided in the optical receptacle of the embodiment of the present invention, FIG. 11-(A) is a left side view, and FIG. 11-(B) is a front view. Thus, by increasing the number of the leaning prevention plates 30, the load applied to the sleeve 25C is dispersed to plural leaning prevention plates 30 and thereby stabilization can be improved.

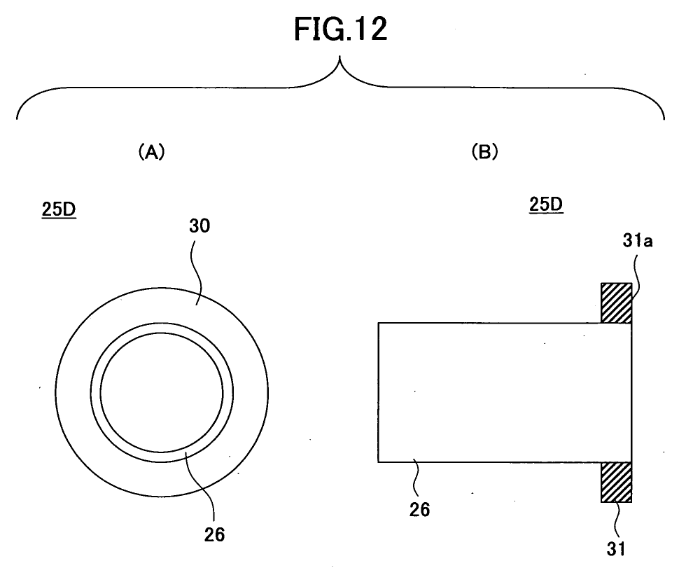

FIG. 12 is a view showing a fourth example of a sleeve provided in the optical receptacle of the embodiment of the present invention, FIG. 12-(A) is a left side view, and FIG. 12-(B) is a front view. As shown in FIG. 12, a leaning prevention ring 31 may be provided on the sleeve main body 26 having the cylindrical-shaped configuration and an end surface 31a of the leaning prevention ring 31 may come in contact with the supporting surface 29A. This structure is equivalent to a structure where the number of provided leaning prevention plates 30 is large and the most stable against the external force.

The present invention is not limited to these embodiments, but variations and modifications may be made without departing from the scope of the present invention.

This patent application is based on Japanese Priority Patent Application No. 2006-178477 filed on Jun. 28, 2006, the entire contents of which are hereby incorporated by reference.

1. An optical receptacle, comprising:
a fiber stub; and
a sleeve having a sleeve main body where the fiber stub is installed, the sleeve supported by a supporting surface of a supporting member;
wherein a leaning prevention member is provided at the sleeve;
the leaning prevention member is formed so as to extend outward from the sleeve main body;
the leaning prevention member prevents leaning of the sleeve main body from the supporting surface by coming in contact with the supporting surface; and
an internal diameter of the sleeve main body is greater than an external diameter of a plug ferrule inserted in the sleeve main body several μm.

2. The optical receptacle as claimed in claim 1,
wherein the leaning prevention member is a plate-shaped member having a structure where at least three portions extend in a radial manner from the center of the sleeve main body having a cylindrical-shaped configuration and an end part comes in contact with the supporting surface.

3. The optical receptacle as claimed in claim 2,
wherein a length in a longitudinal direction of the plate-shaped member is shorter than a length between a contact surface of the fiber stub and the supporting surface.

4. The optical receptacle as claimed in claim 1,
wherein the leaning prevention member is provided on the sleeve main body having a cylindrical-shaped configuration in a ring shape; and
an end surface of the leaning prevention member comes in contact with the supporting surface.

5. The optical receptacle as claimed in claim 1,
wherein a slit forming part extending in a longitudinal direction is formed in the sleeve main body.

6. A sleeve provided in an optical receptacle where a fiber stub is provided, the sleeve being supported by a supporting surface of a supporting member, the sleeve comprising:
a sleeve main body where the fiber stub is installed; and
a leaning prevention member formed so as to extend outward from the sleeve main body, the leaning prevention member being configured to prevent leaning of the sleeve main body from the supporting surface by coming in contact with the supporting surface,
wherein an internal diameter of the sleeve main body is greater than an external diameter of a plug ferrule inserted in the sleeve main body by several μm.

7. The sleeve as claimed in claim 6,
wherein the leaning prevention member is a plate-shaped member having a structure where at least three portions extend in a radial manner from the center of the sleeve main body having a cylindrical-shaped configuration and an end part comes in contact with the supporting surface.

8. The sleeve as claimed in claim 7,
wherein a length in a longitudinal direction of the plate-shaped member is shorter than a length between a contact surface of the fiber stub and the supporting surface.

9. The sleeve as claimed in claim 6,
wherein the leaning prevention member is provided on the sleeve main body having a cylindrical-shaped configuration in a ring shape; and
an end surface of the leaning prevention member comes in contact with the supporting surface.

10. The sleeve as claimed in claim 6,
wherein a slit forming part extending in a longitudinal direction is formed in the sleeve main body.

11. An optical receptacle comprising:
a sleeve having a sleeve main body where a fiber stub is installed,
wherein an internal diameter of the sleeve main body is greater than an external diameter of a plug ferrule inserted in the sleeve main body by several μm.
